(19) United States
(12) Patent Application Publication
(10) Pub. No.: US 2012/0182758 A1
(43) Pub. Date: Jul. 19, 2012

(54) LIGHT GUIDE ASSEMBLY AND OPTICAL ILLUMINATION APPARATUS

(76) Inventor: Günther NATH, Grunwald (DE)

(21) Appl. No.: 13/351,595

(22) Filed: Jan. 17, 2012

(30) Foreign Application Priority Data
Jan. 17, 2011 (DE) 10 2011 008 705.2
Mar. 15, 2011 (DE) 10 2011 013 988.5
Nov. 10, 2011 (DE) 10 2011 118 239.3

(51) Int. Cl. G02B 6/00

(52) U.S. Cl. 362/582

(57) ABSTRACT

The invention improves the optical transmission of a light guide assembly in an optical illumination apparatus achieved by one or more insulation layers which sheath a rigid or flexible light guide rod of the light guide assembly and/or the coupling of light emitted from a radiation source into the light input surface of the light guide rod is improved by an adapter element. Important for the improved transmission in the light guide rod is a highly viscous liquid layer which is in direct contact with the lateral surface of the light guide rod and which includes a perfluoropolyether, particularly Krytox®, Fombline® or Galden®, e.g. Krytox® 16350.

### TECHNICAL FIELD

The present invention relates to improvements in the light output power of a light guide in an optical illumination apparatus. The illumination apparatus may particularly be used for the illumination of cavities, for the optical polymerization of plastics, for the optical curing of adhesives, or for dermatological or cosmetic treatment of a patient. In the latter dermatologic or cosmetic treatment, the optical radiation itself may be used for therapeutic purposes or it may serve to optically increase the efficiency of dermatological or cosmetic substances applied to the human skin.

In the present patent specification, light guides are understood to be of the type having rigid or flexible light guiding cores, i.e. to have a rigid or flexible rod or a rigid or flexible fiber made of a solid like glass or transparent plastics.

### DESCRIPTION OF THE INVENTION

A key quality characteristics of optical light guides is their optical transmittance, i.e. the proportion of the incident light intensity that is output at the light output end of the light guide. The object of the invention is an improvement of the optical transmittance in order to achieve the highest possible radiation intensity at the light output end, particularly when coupling the light guide to an LED radiation source emitting highly divergent light.

This object is met by the light guide assembly having the features defined in one of claims 1, 11, and 12. The remaining claims relate to preferred embodiments.

According to an example, it is particularly desired to introduce, by means of the intensive light, substances contained in dermatologically used ointments, gels or pastes quicker and deeper into the uppermost skin layers in order to enhance their efficiency. As an example, the introducing of anti-inflammatory or analgesic gels, ointments or pastes into the skin with the effective support by the intensive optical radiation at simultaneous surface pressure of the light output surface onto the tissue may be considered.

A further application of an illumination apparatus with the light guide according to the present invention exists in the field of cosmetics. This application mainly focuses on the improved smoothing of wrinkles in the skin by combined application of optical radiation and conventional cosmetic gels, ointments or fluids under an areal pressure exerted onto the tissue.

Another application example of the illumination apparatus with the light guide according to the present invention relates to dermatological and forensic examination. Hereby, the illumination apparatus is desired to optimize the wavelength of the intensive emission light for special optical investigations.

A further application example of the illumination apparatus with the light guide of the present invention resides in the polymerization of light-curing plastics or adhesives.

Moreover, it is possible to use the illumination apparatus with the light guide according to the present invention as a general means for illuminating surfaces and/or cavities in scientific, technological, medical and forensic applications.

As the light source, the present illumination apparatus preferably includes one or more LEDs. However, it is also possible to use other optical radiation sources such as gas discharge lamps or halogen incandescent lamps.

The core of the present invention relates, independently of the above-described application examples, to the general improvement of the light output power in light guide assemblies as they are described later on with reference to FIGS. 1 to 3.

### BRIEF DESCRIPTION OF DRAWINGS

In the following, the light guide assembly and the illumination apparatus of the present invention are explained in more detail with reference to FIGS. 1 to 4 and particular embodiments. Therein shows:

FIG. 1a a cross-sectional view of an illumination apparatus with a light guide assembly according to a first embodiment of the invention;

FIG. 1b a cross-sectional view of an illumination apparatus with a light guide assembly according to a second embodiment of the invention;

FIG. 2 a cross-sectional view of an illumination apparatus with a light guide assembly according to a third embodiment of the invention;

FIG. 3 a cross-sectional view of an illumination apparatus with a light guide assembly according to a fourth embodiment of the invention; and

FIG. 4 a perspective view of an illumination apparatus with a light guide assembly according to a fifth embodiment of the invention.

### DETAILED DESCRIPTION OF SEVERAL EMBODIMENTS

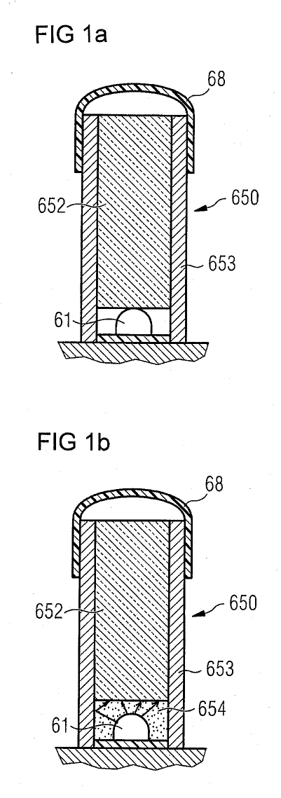

FIGS. 1a and 1b show the application of the light guide assembly (650) in a first and a second preferred embodiment on top of a radiation source (61).

The light guide (650) in this example comprises a light guide rod (652) which has a polished cylindrical surface and likewise polished end surfaces. The light guide rod (652), which may be comprised of glass, silica glass or a transparent plastics, such as acrylic glass, is optically insulated by a tight-fitting fluorocarbon polymer tube, such as a Teflon® FEP or Teflon® MFA tube (653). The tube may comprise a cladding on its inner surface which cladding is made of an amorphous fluorocarbon polymer layer, such as a Teflon AF (Amorphous Fluoropolymer) coating.

In addition, between the inner surface of the insulating tube (653) and the cylindrical surface of the light guide rod (652) there is in line with the present invention a thin layer (not shown) of an amorphous and highly viscous perfluorinated liquid, in particular of a perfluoropolyether, which, as a result of its extremely low refractive index in the range of n≈1.28-1.32 works as an optical immersion liquid to the solid Teflon® AF layer which also has an extremely low refractive index in this range. Thereby, the light guide rod (652) achieves a very high optical aperture (2α≈83° in the case of silica glass, and 2α≈93° in the case of acrylic glass), whereby a particularly high proportion of the solid angle of radiation from a highly divergent emitting light source, such as an LED or an LED array, can be collected by the light guide and transmitted to the outside.

The described type of optical insulation of the light guide rod made of glass or plastics allows for light guide rods having a diameter in the range of a few millimeters even some flexibility of the light guide rod (652) without the danger of splinters or sharp edges in the case of breakage.

For instance, a light guide rod (652) made of acrylic glass and having a length of 1000 mm and a diameter of up to about 6 mm sheathed with a thin-walled (d=0.5 mm) Teflon® FEP tube, which in turn comprises on its inner surface a Teflon® AF or Hyflon® AD-containing layer which in turn further comprises the highly viscous perfluorinated liquid, can be bent by up to 90° without considerable loss of transmission. In case of breakage of such a longer light guide rod, the surrounding tightly fitting sheath tube made of perfluorinated plastics, such as Teflon® FEP or Teflon® MFA with a wall thickness of 0.2 to 1.0 mm, for example, protects against splinters and injury by sharp breaking edges. Flexibility is also provided for rod diameters up to 2 mm in case the light guide rod is made of glass or silica glass.

The optically and mechanically insulating sheath tube of Teflon® FEP or MFA (653) of the rigid or semi-flexible or flexible light guide rod (652) may, but must not necessarily, comprise a solid amorphous perfluorinated inner layer which preferably comprises Teflon® AF. It is also sufficient that merely a thin layer of the perfluorinated highly viscous liquid is provided between the circumferential surface of the light guide (652) and the inner surface of the sheath tube (653).

This liquid may, for example, be a perfluorinated highly viscous polyether having a boiling point above 200° C. and an extremely low refractive index in the range of about 1.28-1.32. Such liquids are commercially available under the trade names Krytox® (DuPont), Fomblin® (Ausimont) or Galden® (Ausimont). In this case, the perfluorinated liquid acts as a means of immersion to the perfluorinated sheath tube (e.g. Teflon® FEP or MFA) which also has a low refractive index (n=1.34) but is not completely transparent like Teflon® AF. For light guide lengths of 10-1000 cm this simplification of the optical insulation does not yet effect a considerable decrease of the transmission of the light guide and is quite simple and inexpensive to manufacture.

FIG. 1b shows another optical immersion filling (654) which optically couples the emitting glass or plastics dome (61) of the LED array with the light input surface of the light guide (652). The volume between the light input surface of the light guide (652) and the LED or the LED dome (61) is completely filled out with the material of the immersion filling (654).

The immersion filling (654) may also be made of a highly transparent elastic silicone gel or silicone rubber or made of polymethylmethacrylate. By means of the immersion filling the coupling-in of light can be improved.

The material of the optical immersion filling element (654) is selected such that an index matching between the refractive indices of the LED plastics housing (61) and the light guide rod (652) is obtained. For common transparent plastics or glasses, the refractive indices of the LED plastics housing (61) and the light guide rod (652) are approximately n≈1.48. If one chooses therefore an optical immersion filling (654) of silicone rubber (n≈1.42) or polymethylmethacrylate (n≈1.49), the radiation passes from the light exit surface of the light source (61) with relatively low losses to the light input surface of the light guide rod (652).

Since the immersion filling (654) (as well as the light guide rod (652)) is confined by the light guide insulation tube (653) and since the refractive index thereof is considerably lower (about n≈1.30 or n≈1.34), there is a light guiding total reflection with a relatively high optical aperture at the outer circumference of the immersion filling (654) (and of the light guide rod (652)). Therefore, a high proportion of the radiation of the LED (61), which would otherwise have been lost, can reach the light guide (652) by a light guiding effect.

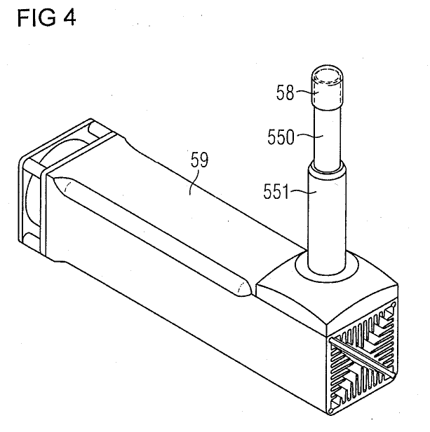

FIGS. 1a and 1b further show a cap (68) which may be set on top of the light output end of the light guide (650). This cap (in the following also referred to as tissue pressing body) allows direct contact to the tissue with the light output surface of the light guide assembly and may easily be exchanged. It will be described later on in further detail by reference to FIG. 4.

In a practical embodiment, a light guide rod of silica glass having a length of 10 cm and a diameter of 8 mm and being optically insulated by a tight fitting Teflon® FEP tube coated with Teflon® AF with an intermediate immersion layer made of the perfluoropolyether (PFPE) Krytox® 16350 between the Teflon® FEP tube and the cylindrical surface of the light guide rod is optically coupled to a diode array (consisting of four single diodes) which irradiate light in the range of 460 nm.

The LED array has an electrical power of 15 Watts and the total emitted radiation has a power of about 3 Watts. The light output power measured at the light guide end is still about 2.8 Watts, while the power density immediately at the light output surface of the light guide is about 5.6 Watts/cm². This power density allows for treating some important dermatological indications (spider veins, age spots, warts, etc.) by the thermal effect of the radiation under tissue pressing. A similar application is so far only known under laser light.

Also, for the curing of light-curing plastics and adhesives with blue light within a few seconds, the power density is fully sufficient. Of course, powerful LEDs or LED arrays in the UV range or in the violet range (about 405 nm wavelength) may be used as well.

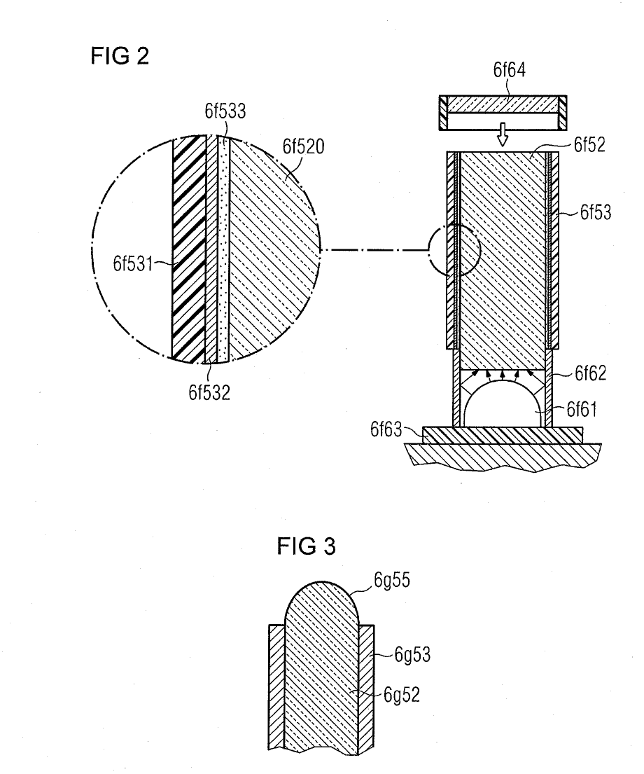

FIG. 2 shows again in detail the optical insulation (6f53) of a light guide (6f52) which is coupled to a highly divergent emitting LED or LED array (6f61). The optical insulation (6f53) may comprise up to three different fluorinated polymers. The light guide consists in this example of a homogeneous well-polished rod of silica glass (6f52 or 6f520) with cylindrical symmetry. On its lateral surface, there are three tightly fitting insulation layers:

The first layer (6f533) is in direct contact with the lateral surface of the light guide rod (6f520) and consists of a liquid or a liquid polymer which is perfluorinated, highly viscous and has an extremely high boiling point (Tₛ>200° C.). Perfluoropolyethers are such liquids.

As an example for such liquids, Krytox®, Fombline® and Galden® may be named. The liquid Krytox® 16350 is suitable, for example.

Next to this layer there is a thin layer (6f32) of a solid amorphous perfluorinated polymer having a thickness d of about 0.3λ-6λ, particularly about 0.3λ-4λ, wherein λ is the optical wavelength of the transmitted light. Teflon® AF or Hyflon® AD or perfluoroalkyl vinyl ether with an increased proportion of copolymers are possible materials for this thin layer (6f532).

The outermost layer (6f531) is a protective tube whose inner surface is coated with the thin layer (6f532) of the amorphous perfluorinated polymer. The protective tube (6f531) preferably consists of a fluorocarbon polymer and has a wall thickness of about 0.1 to 1 mm.

Perfluorinated polymers such as Teflon® FEP, Teflon® MFA, Teflon® PFA, Teflon® PTFE are particularly preferred materials for the protective tube (6f531). But also partially fluorinated polymers, such as the Terpolymer Hostaflon® TFB, may be used as materials for the outer tube (6f531) because of the better flexibility of these tubes.

Since the lateral surface of the light guide rod (6f520) according to the present invention is generally coated with the layer (6f533) made of the perfluorinated or partially fluorinated liquid polymer which as an immersion layer already provides a sufficient index matching to the protective tube (6f531), the solid amorphous inner layer (6f532), which consists of Teflon® AF, for example, may be made very thin for cost reasons, for example only about 0.5λ thick. The solid inner layer (6f532) then prescribes the minimum total layer thickness between the light guide rod (6f520) and the protective tube (6f531), because the liquid layer (6f533) is principally movable and can be displaced by appliance of outer forces such as when the light guide assembly is being bent at particular positions.

In order to save even more material costs for the very expensive inner layer materials like Teflon® AF, it is also possible to completely omit the solid amorphous inner layer (6f532) and to provide only the liquid layer (6f533) as the direct contact medium to the lateral surface of the light guide (5f520). This less expensive optical insulation is also less effective but still very good for light guide lengths up to 1000 cm.

Generally, the immersion layer (6f533) should lead to an at least approximate refractive index matching with the next insulation layer (amorphous layer 6f532 or protective tube 6f531).

The liquid insulation layer (6f533) also provides an important advantage for the mounting process. It is applied prior to the cladding of the light guide rod (6f520) onto the lateral surface thereof. The light guide may then be easily inserted into the tightly fitting protective tube (6f53). The liquid layer (6f533) can remain permanently in the light guide assembly due to its high viscosity and its high boiling point. This optical insulation technology is not only applicable to rigid light guide rods made of silica glass, glass or transparent plastics, but also to flexible light guide fibers of silica glass, glass, and also for light guiding fibers optically insulated with low angles of aperture, made e.g. of quartzglass-quartzglass, or for optical fibers of acrylic glass and other transparent plastics.

The optical illumination apparatus according to FIG. 2 further comprises a tubule (6f62) which is metallized inside and which may be of aluminium, for example. The tubule (6f62) surrounds at a few millimeters length the light entry region of the light guide rod (6f52) with a smallest possible gap between the inner lumen of the tubule (6f62) and the circumferential surface of the light guide rod (6f52), and further surrounds the dome of glass of plastics of the LED (6f61) as far as possible. In an ideal case, the tubule (6f62) extends up to the bottom plate (6f63) which is the PCB board of the LED.

The tubule (6f62) just as the immersion filling (654) described hereinabove with reference to FIG. 1b has the purpose of improving the optical coupling of LED light into the light input surface of the light guide rod (6f52). However, the reflector tubule (6f62) causes a higher heat generation compared to the above-described solution with the immersion filling (654).

The reflective coating on the inner surface of the tubule (6f62) can be made electrolytically or by evaporation deposition or by laminating a reflective foil onto the inner surface of the tubule. In the assembly according to the geometry of FIG. 2, the tubule (6f62) improves the light output power of the light guide (650) by about 25%.

The technology of a more effective coupling of the LED light by means of the reflector tubule (6f62) can also be well used for liquid light guides, i.e. for light guides with a liquid light guiding core, because those light guides comprise a cylindrical light guide rod made of silica glass at their light input end.

The dome of an LED array with four single diodes has a diameter of about 6 mm so that for a light guide rod with 5-6 mm light active diameter and a reflector tubule (6f62) with an inner diameter of about 6 mm a good matching between the LED and the light input surface of the light guide rod can be reached. The light guide rod (6f52) can also be the light input window of a liquid light guide.

At a major mismatch of the cross-sectional surface between the dome (6f61) and the light input surface of the light guide rod (6f52) one can also use reflector tubules (6f62) which are conically tapered inwards or have a stepped profile in the inner lumen.

FIG. 2 shows also a plate (6f64) made of oxide ceramics having a high optical transparency and a good heat conductivity. This plate is positioned detachably onto the light output surface of the light guide. It should have a thickness of more than 1 mm, e.g. a thickness of 10 mm, and should fully cover the light output surface of the light guide rod (6f52). It may also even protrude over the cross-sectional surface of the light guide rod to make the heat conduction even more effective.

A suitable material for this plate which may be pressed onto the tissue in an application for treating a patient is Al₂O₃ or MgO, for example. This plate (6f64), when being pressed onto the tissue, effects a cooling of the tissue surface during the illumination with light and enables the introduction of a much higher radiation energy density into the tissue without burning or coagulating the tissue surface. A potential application of this technology may reside, for example, in the removal of age spots or spider veins or the treatment of acne with light.

FIG. 3 shows a light guide rod (6g52) made of glass, silica glass or acrylic glass. On the circumferential surface thereof, there is an optical insulation (6g53) corresponding to that described with reference to FIG. 2. The light output surface (6g55) of this light guide is approximately curved spherically with a radius of curvature in the magnitude of ½-1 times the diameter of the light guide rod (6g52). The spherical curvature allows a safe positioning of the light output surface on the body portion of a patient to be treated and facilitates thereby the optimum alignment of the emitted light beam.

The curved light output surface (6g55) of the light guide rod (6g52) effects a better homogeneity of the irradiation image. It also allows a better accuracy when contacting tissue, for example, for the treatment of acne or age spots. When using for this light guide rod a light source with low beam divergence instead of an LED, the lens effect of the curved light output surface (6g55) in the near field also produces a slightly increased beam power density. It is also possible to set a silicone cap on top of the curved light output surface (6f55) similar to the cap shown in one of FIGS. 1a, 1b and 4.

In FIGS. 2 and 3 no tissue pressing cap (68) as in FIGS. 1a and 1b is shown on purpose. This is because the improvements of the optical transmission explained on the basis of FIGS. 2 and 3 are available independently from the dermatological and cosmetic applications of FIGS. 1a and 1b and are in themselves a highly relevant aspect of the present invention.

FIG. 4 shows an example of an illumination apparatus according to the present invention comprising a base unit consisting of a handle (59) with a fan and a light emitting diode array (not shown). By means of the light guide assemblies described hereinbefore, coupling of a rigid or flexible light guide (550) to an LED or an LED array being in thermal contact on a handle with cooling is possible. The rigid or flexible light guide (550) is supported on a tubular extension with a base (551). The light input surface of the light guide (550) is located practically in contact with the housing or the dome (61) of an LED array.

The connection of a rigid light guide with the diode array in the above-described highly efficient manner allows to use the LED radiation in body cavities (nose, ear, throat, etc.), because higher radiation power densities can be brought closer to the point of treatment. It is also possible to use the apparatus of FIG. 4 in dentistry for the polymerization of plastic fillings or for industrial applications for curing light-curing plastics on the basis of epoxides, acrylates or silicone elastomers. Thus, the soft flexible cap (58) allows for placing the light guide end for polymerization of a dental filling onto the filling, even under pressure, whereby the highest radiation power density can be used and the oxygen inhibition of the polymerization on the surface can be reduced by mechanical displacement of the atmospheric oxygen.

The cap (58) in FIG. 4 made of soft highly transparent silicone rubber can also be used as a disposable cap so that the light output surface of the rigid light guide, which may also be a rigid fiber rod slightly curved at its light output end, is always clean and available for the polymerization radiation with maximum transparency.

The cap (58) in FIG. 4 or (68) in FIGS. 1a and 1b can also have the form of an elongated hose (also exchangeable as a disposable part) which allows the contact of the rigid or flexible light guide (550, 650) with the tissue for medical applications due to the possibility of sterilization or autoclaving.

In the following, the cap (58 or 68) is again described in greater detail. It consists at least at its radiation output surface of a plastic polymer which is at least translucent, preferably highly transparent. As a material for the cap or the tissue pressing surface one primarily uses silicone rubber but also materials like fluorocarbon polymers (Teflon® FEP, Teflon® MFA, Teflon® PTFE, Hyflon® THV) or polyurethane or polyethylene (also cross-linked).

The pressing of the cap onto the tissue to be treated additionally causes therein a decreased blood flow which results in a deeper penetration of radiation, because blood is a strong light absorber. As a result, an optical treatment of deeper tissue layers with or without active-substance-containing compositions is possible. The material and the geometry of the cap are chosen so that their contact surface increases by at least 5%, preferably at least 10%, when being pressed onto a flat hard test surface with a pressure of at least 0.5 N/cm².

It is also possible to introduce fluorescent dyes directly into the silicone rubber cap (58, 68) which contacts the tissue, to convert the LED light into fluorescent light having a longer wavelength or to obtain at least a colour contribution of longer wavelength to the LED light which is blue, for example, in order to reach a greater depth of penetration of the radiation into the tissue.

This fluorescence technology allows in a simple and cost-effective manner to use a single LED light source in four different color ranges (blue, yellow, red, white) with different penetration depths into the tissue for use in medical or cosmetic applications or for illumination only. The alternative of using four different LED radiation sources would, of course, also be possible but more expensive. The fluorescence technology is not restricted to the use of blue light as pump radiation. However, it works here particularly well due to the maximum efficiency of the diodes in the blue range and the fact that the particularly efficient perylene fluorescent dyes Lumogen® red and Lumogen® yellow (or Lumogen® orange) have their highest absorption or their most efficient pump band in the blue.

Well suited are Lumogen® dyes from the groups of perylenes which well dissolve in the non-polar silicone oils and can therefore be well integrated into the silicone rubber cap (58, 68). But also other fluorescent dyes can be incorporated before the casting and curing of the cap in the liquid phase of the silicone.

For generating longer wavelength fluorescent light in the yellow and red spectrum region under excitation with blue light, it is thus also possible to introduce into the material of the tissue pressing cap made of silicone, which may however also be made from another transparent polymer or elastomer or rubberlike material, instead of Lumogen dyes the following other fluorescent dye or luminescent substances: Dyes based on rare earth materials, such as cerium, samarium, europium, therbium, neodymium and others, which are mostly available built in a glass-like matrix such as (Sr, Ba, Ca)₂SiO₂ or in a crystalline matrix such as yttrium-aluminium-garnet (Y₂Al₅O₁₂), or in finely powdered form.

But also dye or luminescent substances on the basis of transition metals like Ti, Cr, Mn, Fe, Co, Ni, Cu, etc. may be integrated into the tissue pressing cap or mixed therein before the final cross-linking (silicone) or curing, if those substances are built into a crystalline matrix or present in powdered form.

As an example, reference is here made to a luminescent substance consisting of powdered ruby, i.e. chrome ions in a matrix of crystalline Al₂O₃. This luminescent substance absorbs in the blue and violet spectrum region and is fluorescent in the longer wavelength red spectrum region at 694 nm.

Or one incorporates finely powdered acrylic glass (plexiglass) into the silicone of the tissue pressing cap, or other powdered transparent plastics doped with a perylene dye (Lumogen®), so that the perylene molecules are in a matrix of acrylic glass or another plastics. This is of advantage because the perylenes in such a matrix like acrylic glass are particularly photostable and provide particularly effective fluorescence.

Further, fluorescent substances on the basis of quantum dots such as CaTe or (Cd, Se) ZnS or PbSe, also in form of nano pigments, can be incorporated into the pressing cap.

The tissue pressing caps made of silicone doped with luminescent substances may after the cross-linking be, particularly at the tissue pressing surface, additionally coated with a thin layer of silicone (thickness of the layer≈0.1 mm-1 mm), to avoid that the luminescent substances come into contact with the tissue.

Further to all these dyes or luminescent substances in silicone or other transparent polymers or elastomers, one can add finely granulated SiO₂ powder (more generally: glass powder or powder of Al₂O₃) in order to improve the homogeneity and the effectivity of the emitted fluorescent radiation. The SiO₂-containing powder can here be used up to the finest possible granulation in the nano range.

It is thus possible to produce with a silicone cap which is, for example, doped with rare earth substances Eu and/or Ce by addition of SiO₂-containing powder under excitation with an LED emitting in the blue range at about 460 nm very homogeneous diffuse white light which is particularly suitable as diagnosis light not only for dermatological applications but also in forensic science, for example.

But also glass powder such as glass bubbles or Al₂O₃ powder, in particular SiO₂ powder alone in the silicone cap, i.e. without additional luminescent substances, can be useful. It works as a light diffuser and can in particular cases be useful in the application of light radiation in body cavities, for example.

When using the illumination apparatus according to FIGS. 1 to 4 for the light or UV curing, for example of materials on the basis of epoxide acrylate or silicone elastomer, wherein the radiation output surface may or should be in contact with the plastics to be cured, it may be preferable due to the better anti-adhesive property to use a cap whose radiation output surface consists of a fluorocarbon polymer. Particularly advantageous for this purpose are perfluorinated polymers such as Teflon® FEP or Teflon® MFA. Thin foils (d=0.5 mm) of these materials transmit in both UVA and the visible light spectrum more than 80% and are also sterilizable and autoclavable for medical applications.

In the following, the radiation source (61, 6f61), which is only schematically shown in FIGS. 1a, 1b and 2 and not shown at all in the remaining Figures for better clarity, is described in more detail:

The radiation source (61) may be a conventional optical light source, e.g. a vapor discharge lamp, but comprises preferably one or more light-emitting diodes (LEDs). Particularly preferred is a diode array which is composed of four or six or even more LEDs which are mostly connected to each other in series or parallel. In battery mode, it is also possible to connect the LEDs in pairs in parallel to each other. The total electrical power of the diode arrays lies between 5 and 30 Watts, preferably in the range from 5 to 25 Watts, more preferably in the power range between 8 and 18 Watts.

The diodes of the array may emit in the spectral region between 320 nm and 1500 nm, preferably between 350 nm and 1000 nm. The diodes may all emit in the same spectral region or mixed into two different spectral regions. It is, for example, possible to use an array consisting of four single diodes wherein two diodes emit in the red region and two diodes emit in the blue region. It is possible to combine two diodes in the blue region with two diodes in the UVA region with each other. The choice of the spectral regions of the diodes depends on whether it is desired to reach a greater penetration depth into the tissue (red, near infrared) or a smaller penetration depth (blue, violet) or also an additional photochemical effect by formation of radicals (UVA, violet).

### LIST OF REFERENCE SIGNS

58 cap top part
59 main body
61 irradiation source
68 cap top part
550 light guide assembly
551 intermediate part
650 light guide assembly
652 light guide rod
653 insulation layer(s)
654 immersion filling element
6f52 light guide rod
6f53 insulation layer(s)
6f520 light guide rod
6f531 outer protective tubing layer
6f532 thin layer
6f533 liquid layer
6f61 irradiation source
6f62 reflector element
6f63 main body
6f64 Al₂O₃ top part
6g52 light guide rod
6g53 insulation layer(s)
6g55 curved light exit surface

1. A light guide assembly comprising:
a rigid or flexible light guide rod sheathed by at least one insulation layer, wherein the at least one insulation layer comprises a liquid layer made of a liquid perfluorinated or partially fluorinated polymer.

2. The light guide assembly of claim 1, wherein the liquid layer is highly viscous and has a boiling point above 200° C.

3. The light guide assembly of claim 1, wherein the liquid layer is in direct contact with a lateral surface of the light guide rod and has a refractive index between 1.28 and 1.32.

4. The light guide assembly of claim 1, wherein the liquid layer comprises a perfluoropolyether made of at least one of Krytox®, Fombline® and Galden®.

5. The light guide assembly of claim 1, wherein the at least one insulation layer further comprises:
a thin layer made of a solid amorphous perfluorinated polymer with an increased copolymer proportion, which has a thickness corresponding to approximately 0.3 to 6 times the wavelength of transmitted light.

6. The light guide assembly of claim 1, wherein the at least one insulation layer further comprises an outer protective tubing layer formed of a fluorocarbon polymer, wherein the fluorocarbon polymer is one of the materials including Teflon® FEP, Teflon® MFA, Teflon® PFA, Teflon® PTFE and Hostaflon® TFB.

7. The light guide assembly of claim 1, further comprising a reflector element which is mirror-coated on an inner wall thereof and has a generally cylindrical form, wherein the reflector element is provided between a main body and the light guide rod so as to improve coupling of light emitted from a radiation source into the light guide rod.

8. The light guide assembly of claim 7, wherein a first end of the reflector element at least partially surrounds the light output surface of the radiation source, and a second end of the reflector element surrounds a light input end of the light guide rod.

9. The light guide assembly of claim 1, further comprising an immersion filling element provided between the light guide rod and a radiation source, wherein the refractive index of the immersion filling element is selected for refractive index matching to the light output surface of an LED radiation source and to the light guide rod to improve the coupling of light emitted from the LED radiation source into the light guide rod.

10. The light guide assembly of claim 9, wherein the immersion filling element is transparent and includes a highly transparent soft and elastic material including at least one of silicone gel, silicone rubber, or a transparent plastic.

11. A light guide assembly comprising:
a rigid or flexible light guide rod; and
an adapter element provided between a main body of the assembly and the light guide rod to improve coupling of light emitted from an LED radiation source into the light guide rod,
wherein the adapter element is a reflector element with a mirror coating on its inner wall and having a generally cylindrical form, wherein a first end of the reflector element at least partially surrounds a light output surface of the LED radiation source and a second end of the reflector element surrounds a light input end of the light guide rod.

12. A light guide assembly comprising:
a rigid or flexible light guide rod; and
an adapter element provided between a main body of the assembly and the light guide rod to improve coupling of light emitted from an LED radiation source into the light guide rod,
wherein the adapter element is an immersion filling element provided between the light guide rod and the LED radiation source, and wherein a refractive index of the immersion filling element is selected for refractive index matching to a light output surface of the LED radiation source and to the light guide rod.

13. The light guide assembly of claim 12, wherein the immersion filling element comprises at least one of a highly transparent, soft and elastic material or a transparent plastic material.

14. The light guide assembly of claim 13, wherein the immersion filling element comprises silicone gel, silicone rubber or polymethylmethacrylate.

15. The light guide assembly of claim 1, wherein the light guide rod is formed of silica, silica glass or acrylic glass.

16. The light guide assembly of claim 1, further comprising a top part element configured to be placed onto a light output end of the light guide rod, wherein the top part element is formed of Al2O3 of MgO.

17. The light guide assembly of claim 1, wherein the light output surface of the light guide rod is approximately curved spherically, wherein a radius of curvature of light output surface corresponds approximately to a value which is ½ to 1 times a diameter of the light guide rod.

18. An optical illumination apparatus comprising a main body having a radiation source for emitting light in a wavelength region between 320 nm and 1500 nm, and an intermediate member configured to be placed on top of the main body to guide the light from the radiation source into the direction of an object to be irradiated, wherein the intermediate member comprises the rigid or flexible light guide assembly of claim 1.

19. The optical illumination apparatus of claim 18 for dermatological or cosmetic treatment of a patient, further comprising a top part element arranged at a light output end of the intermediate member and adapted to be brought into direct contact with a body portion of the patient to be treated, wherein the top part element comprises an elastomer and is deformable when being pressed against the body portion to be treated.

20. The optical illumination apparatus of claim 18, wherein the top part element further comprises at least one of a glass powder, a Al2O3 powder, a carbon powder and a fluorescent dye.
